(19) United States
(12) Patent Application Publication
(10) Pub. No.: US 2006/0278720 A1
(43) Pub. Date: Dec. 14, 2006

(54) Multimedia memory card

(75) Inventor: Chin-Chun Liu, Miaoli Hsien (TW)

Correspondence Address: BACON & THOMAS, PLLC, 625 SLATERS LANE, FOURTH FLOOR, ALEXANDRIA, VA, 22314, US

(73) Assignee: Sun-Light Electronic Technologies Inc., Miaoli Hsien (TW)

(21) Appl. No.: 11/251,822

(22) Filed: Oct. 18, 2005

(30) Foreign Application Priority Data
Jun. 14, 2005 (TW) 94209919

(51) Int. Cl. G06K 19/06

(52) U.S. Cl. 235/492

(57) ABSTRACT

A multimedia memory card comprises a cover body having a top surface and a side wall extending from the periphery of the top surface and a control circuit. The top surface and the side wall form a holding space. The circuit board has at least a first flash memory, a second flash memory, a control chip, and a plurality of passive components. The first flash memory is disposed adjacent to the second flash memory. The control chip and the passive components are disposed on one side of the first flash memory or second flash memory. The holding space of the cover body is designed to hold the first flash memory, the second flash memory, the control chip, and the passive components of the circuit board.

### BACKGROUND OF THE INVENTION

1. Field of the Invention

The present invention relates to a multimedia memory card, and more particularly, to an improved multimedia memory card having a plurality of flash memories therein.

2. The Description of the Related Prior Art

With great advances in integrated circuit technology and materials, there are wider integrated circuits applications. Moreover, various integrated circuit products are produced, with more powerful and tend to thin and compact, examples are electronic dictionaries, digital cameras, digital video cameras, and so on. Taking the digital camera as an example, as a large volume of digital information is required to be recorded, an electronic media, such as memory, is needed for the digital camera, thereby developing a multimedia memory card (MMC), by integrating a memory chip and a thin card. Hence, the card so formed is capable of storing information and is very compact and fits for the tendency of electronic products, so it becomes widely applicable.

With development in digital technology, a wide range of digital electronic products comes into existence; relies on improving the same old audiovisual products to achieve maximum storage functionality with the minimum memory required, such as digital video cameras, digital cameras, multimedia players, digital projectors, digital audio recorders, etc. As the majority of the above-mentioned information and electronic products are portable, information is required to be stored in a compact MMC. In addition, as the core of MMC is the flash memory, which is capable of storing, reading, deleting, and processing data multiple times, but the storage capacity of flash memory for the conventional MMC is generally limited for digital peripheral products, it is a major issue to study how the MMC can achieve a greater memory capacity, under constant volume of MMC.

### SUMMARY OF THE INVENTION

It is the primary object of the present invention to provide a multimedia memory card, which is capable of increasing the number of flash memories to increase the volume of memories, under constant volume of MMC.

To achieve the aforementioned objects of the present invention, the MMC card comprises a cover body having a top surface and a side wall extending from the periphery of the top surface and a circuit board. The top surface and the side wall form a holding space. The circuit board has at least a first flash memory, a second flash memory, a control chip, and a plurality of passive components. The first flash memory is disposed adjacent to the second flash memory. The control chip and the passive components are disposed on one side of the first flash memory or second flash memory. The holding space of the cover body is designed to hold the first flash memory, the second flash memory, the control chip, and the passive components of circuit board.

### BRIEF DESCIPTION OF THE DRAWINGS

The structure and the technical means adopted by the present invention to achieve the above and other objects can be best understood by referring to the following detailed description of the preferred embodiments and the accompanying drawings, wherein

FIG. 1 shows an exploded view of the multimedia memory card according to the present invention.

FIG. 2 shows a top elevational view of the multimedia memory card according to the present invention.

FIG. 3 shows a cross-sectional view along line A-A of FIG. 2 of the present invention.

FIG. 4 shows a top elevational view of the circuit board according to the present invention.

FIG. 5 shows a cross-sectional view along line B-B of FIG. 4 of the present invention.

### DETAILED DESCRIPTION OF THE PREFERRED EMBODIMENTS

While the invention has been described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

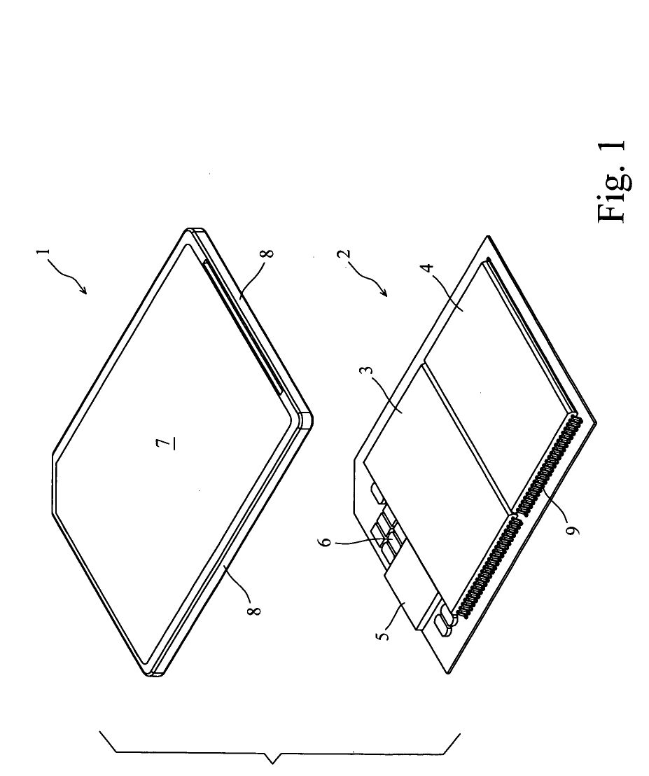

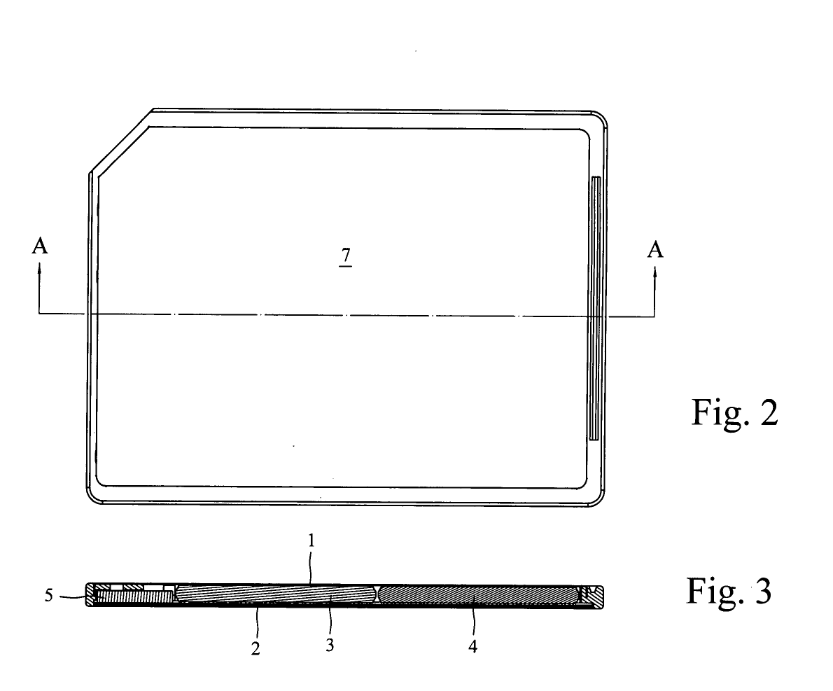

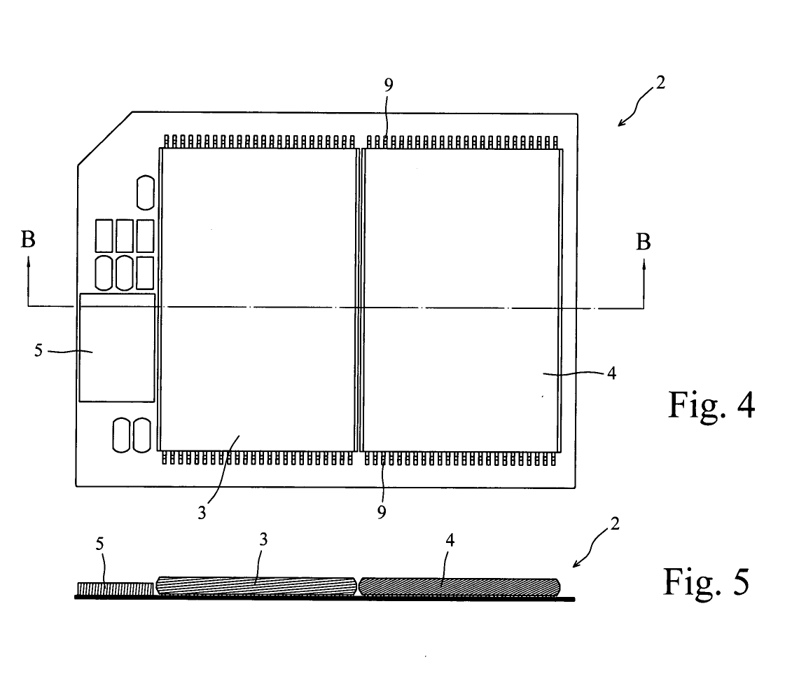

Referring to FIG. 1, FIG. 2, FIG. 3, FIG. 4 and FIG. 5, the drawings show the exploded view of the multimedia memory card of the present invention, the top elevational view of the multimedia memory card, the cross-sectional view along line A-A of FIG. 2, the top elevational view of the circuit board, and the cross-sectional view along line B-B of FIG. 4 respectively. The multimedia memory card of the present invention comprises a cover body 1 having a top surface 7 and a side wall 8 extending from the periphery of the top surface 7 and a circuit board 2. The top surface 7 and the side wall 8 form a holding space. The circuit board 2 has at least a first flash memory 3, a second flash memory 4, a control chip 5, and a plurality of passive components 6.

The cover body 1 is formed by stainless steel and plastic material, wherein the top surface 7 is made of stainless steel. The first flash memory 3 is disposed adjacent to the second flash memory 4. A plurality of pins 9 are sequentially and parallel arranged onto the corresponding sides of the first flash memory 3 and second flash memory 4. One end of each of the pins 9 is joined to the first flash memory 3 or second flash memory 4, whereas the other end of each of the pins 9 is joined to the circuit board 2. The control chip 5 and the passive components 6 are disposed on one side of the first flash memory 3.

The holding space of the cover body 1 is designed to hold the first flash memory 3, the second flash memory 4, the control chip 5, and the passive components 6 of the circuit board 2 in order to form the MMC of the present invention at maximum compactness without reducing the strength of the structure.

The cover body 1 and the circuit board 2 are joined by plastic solvent, which can strengthen the joining of the cover body 1 and the circuit board 2, thereby achieving the best fitness by plastic molding method. In addition, the product is capable of resisting impact, and does not easily to be detached, so the first flash memory 3, the second flash memory 4, the control chip 5, and the passive components 6 of the circuit board 2 can be protected.

While the invention has been described by way of examples and in terms of preferred embodiments, it is to be understood that the invention is not limited thereto. To the contrary, those who are familiar with the subject art can carry out various modifications and similar arrangements and procedures, under the scope of appended claims and broadest interpretation. For example, the position of the first flash memory and the second flash memory can be exchanged.

What is claimed is:

1. A multimedia memory card comprising:
a cover body having a top surface and a side wall extending from the periphery of said top surface, said top surface and said side wall forming a holding space; and
a circuit board having at least a first flash memory, a second flash memory, a control chip and a plurality of passive components;
wherein said first flash memory is disposed adjacent to said second flash memory, and said control chip and said passive components are disposed on one side of said first flash memory or said second flash memory, and the holding space of said cover body is designed to hold said first flash memory, said second flash memory, said control chip, and said passive component of said circuit board.
